(19) United States
(12) Patent Application Publication
(10) Pub. No.: US 2007/0218770 A1
(43) Pub. Date: Sep. 20, 2007

(54) Card connector

(75) Inventors: Hitoshi Kikuchi, Tokyo (JP); Hirokazu Takahashi, Tokyo (JP); Kazunori Takei, Tokyo (JP)

Correspondence Address: ABELMAN, FRAYNE & SCHWAB, 666 THIRD AVENUE, 10TH FLOOR, NEW YORK, NY, 10017, US

(73) Assignee: DDK LTD.

(21) Appl. No.: 11/716,226

(22) Filed: Mar. 8, 2007

(30) Foreign Application Priority Data
Mar. 15, 2006 (JP) 2006-71,172

(51) Int. Cl. H01R 24/00

(52) U.S. Cl. 439/630

(57) ABSTRACT

A card connector includes contacts of two kinds for two memory cards, each adapted to contact a connection portion of the memory card, and a housing having two inserting openings each into which the respective memory card is inserted and arranging and holding the contacts. The two inserting openings are arranged one above the other substantially in parallel relationship, and an insertion-preventing member is arranged in a position between the inserting openings so as not to contact the contacts of two kind so that once either of the memory cards has been inserted, the other memory card is prevented from being inserted by means of the insertion-preventing member. The card connector thus constructed is simple in construction and easy to remove the memory card and can achieve a miniaturization of the connector without limiting design of circuits of substrate.

### BACKGROUND OF THE INVENTION

This invention relates to a card connector for use in a various electric and electronic appliances such as printers, card readers and the like for inputting and outputting signals into and from memory cards of a plurality of kinds inserted into the card connector, and more particularly to a card connector having a structure permitting one memory card only to be inserted at a time.

In recent years, with the wide spread use of digital cameras and the like, memory cards having a large storage capacity and a compact shape have been used. A wide variety of cards have been used depending upon characteristics and the like of appliances with which the memory cards are used, for example, SD card (Secure Digital memory card) (registered trademark, referred to hereinafter just as “SD card”), Memory Stick card (registered trademark, referred to hereinafter just as “MS card”), SmartMedia card (registered trademark, referred to hereinafter just as “SM card”), CompactFlash card (registered trademark, referred to hereinafter just as “CF card”), xD card (registered trademark, referred to hereinafter just as “xD card”), Multimedia card (registered trademark, referred to hereinafter just as “MM card”), and the like. Accordingly, as devices for writing and reading onto and from these various memory cards, memory card reader writers are increasingly being used in computers themselves or as peripheral devices.

As a matter of course, it is preferable that the memory card reader writer can accept various memory cards. In the memory card reader writers of the prior art, therefore, a card connector is arranged on a reader writer itself to make it possible to insert various memory cards into the card connector, thereby enabling the inserted memory cards to be read out and written onto.

As described above, there are many kinds of memory cards, such as SD, MS, SM, CF, xD, MM cards and the like. The memory card reader writers can be used for all or some of these memory cards. Practically, card connectors have inserting openings into which corresponding memory cards can be inserted. By way of example, a card connector corresponding to three kinds of memory cards, or SD, xD and MS cards will be explained here.

For example, the card connector accommodating SD, xD and MS cards includes a plurality of contacts arranged and held in a housing so as to be able to contact respective terminals of each of inserted memory card. In this way, the card connector is constructed to be able to read from and write onto the memory card by inserting it into the card connector. An inserting opening is provided at an upper portion for inserting one SD card, while an inserting opening is provided on the left of a lower portion for one MS card and an inserting opening on the right of the lower portion for one xD card.

With the card connector of such a structure, a desired memory card, for example, a CF card is inserted into an inserting opening for the CF card to perform reading and writing with the CF card.

In general, a card connector into which a plurality of memory cards can be inserted, includes an integrated circuit for commonly controlling the respective memory cards. When two or more memory cards are inserted into the card connector at a time, integrated circuit errors frequently occur. In order to avoid these errors, two methods may be considered. One method is to provide integrated circuits exclusive to the respective memory cards. The other method is to provide a connector having a structure not permitting two or more memory cards to be inserted at a time. The former method is very difficult to realize it in terms of overloaded substrate layout and severely limited occupied area of substrate in the present state of rapidly proceeding miniaturization of appliances, and what is worse still this method would increase the manufacturing cost.

In order to realize the second method, therefore, card connectors having a plurality of inserting openings for cards have been proposed, which, once a card has been inserted, can prevent a further card from being inserted, for example, in Japanese Patent Application Opened No. 2003-297,489 (Patent Literature 1), Japanese Patent Application Opened No. 2005-340,141 (Japanese Patent Application No. 2004-161,293) (Patent Literature 2) filed by the applicant of the present application, and Japanese Patent Application No. 2004-307,794) (Patent Literature 3) also filed by the applicant.

Patent Literature 1

According to the abstract of the Japanese Patent Application Opened No. 2003-297,489, this invention has an object to provide a memory card connector which is able to prevent a further memory card from being inserted, after once a memory card has been inserted among a plurality of admissible memory cards. Disclosed is a memory card connector allowing a plurality of memory cards to be inserted, comprising a connector main body having a plurality of inserting openings opening in the form of shapes corresponding to the memory cards to be inserted and forming in the inserting openings spaces in which contacts are provided so as to electrically contact electrodes of the memory cards to be inserted, and a slide cover provided outside said inserting openings so as to be movable along the opening surface of said inserting openings and having card inserting openings opening in the form of shapes corresponding to the memory cards to be inserted to form pairs with said inserting openings of the connector main body but shifted from relative positions of said inserting openings of the main body. With this memory card connector, therefore, when the centers of one pair of the space of the main body and the card inserting opening of the slide cover are aligned with each other, centers of other spaces of the main body and other card inserting openings of the slide cover corresponding thereto are not aligned with each other.

Incidentally, claim of the Patent Literature 1 recites a memory card connector into which a plurality of memory cards can be inserted, comprising a connector main body consisting of a housing having a plurality of inserting openings opening in the form of shapes corresponding to the memory cards to be inserted and forming in the inserting openings spaces in which contacts are provided so as to electrically contact electrodes of the memory cards to be inserted, and a slide cover provided outside said inserting opening of the connector main body so as to be movable along the opening surface of said inserting openings of the connector main body and having card inserting openings opening in the form of shapes corresponding to the memory cards to be inserted to form pairs with said inserting openings of the connector main body so that when the centers of one pair of the space of the connector main body and one card inserting opening of the slide cover coincide with each other, centers of other pairs of spaces and other card inserting openings do not coincide with each other.

Patent Literature 2

According to the abstract of the Japanese Patent Application No. 2004-161,293, this invention has an object to provide a card connector which, once a card has been inserted, can prevent the other card from being inserted, and achieves the miniaturization of the connector without limiting circuit design of a substrate and without impeding the high density of conductors and which is easy to design its housing and easy to remove the card. The disclosed card connector comprises a required number of contacts adapted to contact connection portions of a plurality of memory cards and a housing having a plurality of inserting openings into which the plurality of memory cards are inserted and arranging and holding the contacts therein, wherein the housing is provided at predetermined positions with at least one locking member which is movable or pivotally movable upon insertion of one kind of memory card and at least one spring member which is displaceable upon insertion of one kind of memory card so as to permit only one kind of memory card to be inserted at a time by means of the locking and spring members.

In the Japanese Patent Application No. 2004-161,293, incidentally, claim 1 recites a card connector into which a plurality of memory cards are detachably inserted, comprising a required number of contacts adapted to contact connection portions of a plurality of memory cards and a housing having a plurality of inserting openings into which the plurality of memory cards are inserted and arranging and holding the contacts therein, wherein the housing is provided at predetermined positions with at least one locking member which is movable or pivotally movable upon insertion of one kind of memory card and at least one spring member which is displaceable upon insertion of one kind of memory card so as to permit only one kind of memory card to be inserted by means of the locking and spring members. Claim 2 recites a card connector into which a plurality of memory cards are detachably inserted, comprising a required number of contacts adapted to contact connection portions of a plurality of memory cards and a housing having a plurality of inserting openings into which the plurality of memory cards are inserted and arranging and holding the contacts therein, wherein said housing is provided with two inserting openings arranged substantially parallel to each other and one inserting opening above said two inserting openings and there is provided a locking member which is located at the intermediate position between said two inserting openings and is movable or pivotally movable upon a memory card being inserted into either of said two inserting openings, and further there is provided a spring member which is located below the one upper inserting opening and is displaceable upon a memory card being inserted into the one upper inserting opening so that only one kind of memory card is permitted to be inserted by means of said locking member and said spring member. Claim 3 recites a card connector as claimed in claim 1 or 2, wherein when one kind of memory card has been inserted into the inserting opening of said housing, said locking member is moved or pivotally moved to extend into the inserting opening arranged parallel to said inserting opening into which the memory card has been inserted so that said spring member is prevented from being displaced, thereby permitting only one kind of memory card to be inserted into the card connector. Claim 4 recites a card connector as claimed in claim 1 or 2, wherein when one kind of memory card has been inserted into the inserting opening of said housing, said spring member is displaced so that part of said displaced spring member extends into the other inserting opening, thereby permitting only one kind of memory card to be inserted into the card connector. Claim 5 recites a card connector as claimed in any one of claims 1 to 4, wherein if necessary, any one of said inserting openings has a part common to the other inserting openings.

Patent Literature 3

According to the abstract of the Japanese Patent Application No. 2004-307,794, this invention has an object to provide a card connector 10 which, once a card has been inserted, can prevent the other card from being inserted, and achieves the miniaturization of the connector without limiting circuit design of a substrate and without impeding the high density of conductors and which is simple in construction and is easy to design its housing and easy to remove the card. Disclosed is a card connector 10 into and from which a plurality of memory cards 50 are detachably inserted and removed, comprising a plurality of contacts 14 adapted to contact connection portions of the plurality of memory cards 50 and a housing 12 having a plurality of inserting openings 22 for inserting the plurality of memory cards 50 and arranging and holding the contacts 14 therein, wherein the housing is provided at predetermined positions with a required number of sliders 20 forming parts of the plurality of inserting openings 22, and a required number of holders 18 for movably fixing the sliders 20 so that only one kind of memory card is permitted to be inserted by means of the sliders 20.

In this Japanese Patent Application No. 2004-307,794, incidentally, claim 1 recites a card connector into and from which a plurality of memory cards are detachably inserted and removed, comprising a plurality of contacts adapted to contact connection portions of the plurality of memory cards and a housing having a plurality of inserting openings for inserting the plurality of memory cards and arranging and holding the contacts therein, wherein said housing is provided at predetermined positions with a required number of sliders forming parts of said plurality of inserting openings, and a required number of holders for movably fixing said sliders so that only one kind of memory card is permitted to be inserted at a time by means of said sliders. Claim 2 recites a card connector into and from which a plurality of memory cards are detachably inserted and removed, comprising a plurality of contacts adapted to contact connection portions of the plurality of memory cards and a housing having a plurality of inserting openings for inserting the plurality of memory cards and arranging and holding the contacts therein, wherein said housing is provided with four inserting openings arranged on the left, right, top and bottom substantially parallel to one another and one inserting opening arranged at intermediate position of and below the inserting openings arranged on the left and the right, and said housing is provided substantially at intermediate positions of the inserting openings arranged on the left and the right with a required number of sliders forming parts of said five inserting openings and a holder for movably fixing said sliders so that only one kind of memory card is permitted to be inserted by means of said sliders. Claim 3 recites a card connector as claimed in claim 1 or 2, wherein the parts of said inserting openings are formed by combinations of concave portions and convex portions. Claim 4 recites a card connector as claimed in claim 2, wherein the parts of said four inserting openings arranged on the left, right, top and bottom are formed by four concave portions, and the part of said inserting opening arranged at intermediate lower position is formed by one convex portion. Claim 5 recites the card connector as claimed in claim 3 or 4, wherein said slides are formed with an inserting hole for receiving said holder, and the tip of said holder is alternately divided so that said sliders are movably fixed. Claim 6 recites the card connector as claimed in claim 4, wherein said sliders are formed with a longitudinally elongated inserting hole for receiving said holder, and the tip of said holder is alternately divided into the three parts so that said sliders are fixed movably in the longitudinally length direction (direction of thickness). Claim 7 recites the card connector as claimed in any one of claims 1 to 6, wherein the parts of said inserting openings are formed by the combinations of said concave portions and said convex portions such that by the movement of said sliders only one inserting opening permits said memory card to be inserted.

In the Japanese Patent Application Opened No. 2003-297,489 (Patent Literature 1), the card connector includes the slide cover which is mounted as a separate part on the surface of the housing and is slidably moved in lateral directions so that when only the center of one card inserting opening of the slide cover for one kind of the memory card coincides with the center of one inserting opening of the housing for one kind of the memory card, the centers of the other card inserting openings of the slide cover do not coincide with the centers of the inserting openings of the housing, thereby preventing more than one memory card from being inserted at a time.

Recently, with the strong requirement for the more miniaturization of appliances, there is a very strong need for connectors to be more miniaturized. Under such circumstances, with the construction disclosed in the Patent Literature 1, the slide cover provided in front of the inserting openings of the housing would go against the trend of the miniaturization of the connector. Moreover, the slide cover would limit circuit design of substrates (for example, making impossible on the fitting side to arrange the connection portions of a connector to be connected to a substrate) and would cause a problem impeding the high-density structure for loading a plurality of memory cards.

Further, the structures permitting only one memory card to be inserted at a time disclosed in the Patent Literatures 2 and 3 described above are too complicated in construction for card connectors enabling only two memory cards to be inserted.

### SUMMARY OF THE INVENTION

The invention has been made in view of these problems of the prior art and has an object to provide a card connector which is simple in construction and, once a memory card has been inserted, is able to prevent a further memory card from being inserted, and which can achieve a miniaturization of the connector without limiting design of circuits of a substrate and without impeding high-density of conductors and is easy to design a housing and to remove the memory card.

The object of the invention can be accomplished by the card connector 10 into and from which two memory cards 50 are detachably inserted and removed, including contacts 14 and 16 of two kinds for said two memory cards 50, respectively, each adapted to contact a connection portion of the memory card 50, and a housing 12 having two inserting openings 22 each into which the respective memory card 50 is inserted and arranging and holding said contacts 14 and 16, according to the invention said two inserting openings 22 provided in said housing 12 are arranged one above the other substantially in parallel relationship, and an insertion-preventing member 20 is arranged in a position between said inserting openings 22 so as not to contact said contacts 14 and 16 of two kind so that once either of the memory cards 50 has been inserted, the other memory card is prevented from being inserted by means of said insertion-preventing member 20.

Said insertion-preventing member 20 at least comprises a holding portion 28 for holding the insertion-preventing member in said housing, an elastic portion 32 having an elasticity and being contiguous to said holding portion 28, and two projections consisting of an upper projection 301 and a lower projection 302 located at a tip of said elastic portion 32, and said housing 12 is formed with an inserting groove 26 for receiving said insertion-preventing member 20 therein so as to permit the elastic portion 32 of said insertion-preventing member 20 to be displaceable.

Moreover, when either of said two memory cards 50 has been inserted into one of the inserting openings 22, one of said two projections is pushed by said memory card 50 so that said elastic portion 32 is displaced to cause the other projection 30 to extend into the other inserting opening 22, thereby permitting only one memory card 50 to be inserted at a time.

As can be seen from the above description, the card connector 10 according to the invention has the following significant functions and effects.

(1) In a card connector 10 into and from which two memory cards 50 are detachably inserted and removed, including contacts 14 and 16 of two kinds for said two memory cards 50, respectively, each adapted to contact a connection portion of the memory card 50, and a housing 12 having two inserting openings 22 each into which the respective memory card 50 is inserted and arranging and holding said contacts 14 and 16, according to the invention said two inserting openings 22 provided in said housing 12 are arranged one above the other substantially in parallel relationship, and an insertion-preventing member 20 is arranged in a position between said inserting openings 22 so as not to contact said contacts 14 and 16 of two kind so that once either of the memory cards 50 has been inserted, the other memory card is prevented from being inserted by means of said insertion-preventing member 20. Therefore, it is possible to provide a card connector 10 which is simple in construction to permit only one memory card 50 to be inserted at a time and hence, of course, eliminates any occurrence of errors in integrated circuits for controlling the memory cards, without limiting design of circuits of the substrate and without impeding high-density of conductors and which is easy to design the housing and to remove the memory card 50.

According to the invention, said insertion-preventing member 20 at least comprises a holding portion 28 for holding the insertion-preventing member in said housing, an elastic portion 32 having an elasticity and being contiguous to said holding portion 28, and two projections consisting of an upper projection 301 and a lower projection 302 located at a tip of said elastic portion 32, and said housing 12 is formed with an inserting groove 26 for receiving said insertion-preventing member 20 therein so as to permit the elastic portion 32 of said insertion-preventing member 20 to be displaceable. Consequently, the card connector according to the invention can permit only one memory card to be inserted at a time with a simple construction.

According to the invention, when either of said two memory cards 50 has been inserted into one of the inserting openings 22, one of said two projections is pushed by said memory card 50 so that said elastic portion 32 is displaced to cause the other projection 30 to extend into the other inserting opening 22, thereby permitting only one memory card 50 to be inserted at a time. Therefore, it is possible to provide a card connector 10 which is simple in construction to permit only one memory card to be inserted at a time and hence, of course, eliminates any occurrence of errors in integrated circuits for controlling the memory cards, without limiting design of circuits of the substrate and without impeding high-density of conductors and which is easy to design the housing and to remove the memory card.

The invention will be more fully understood by referring to the following detailed specification and claims taken in connection with the appended drawings.

### BRIEF DESCRIPTION OF THE DRAWINGS

FIG. 1A is a perspective view of a card connector according to the invention;

FIG. 1B is a perspective view of an insertion-preventing member according to the invention;

FIG. 2A is a cross-sectional view of the connector taken along the insertion-preventing member;

FIG. 2B is a cross-sectional view similar to FIG. 2A with a card inserted in the upper portion of the connector;

FIG. 2C is also a cross-sectional view similar to FIG. 2A with a card inserted in the lower portion of the connector;

FIG. 3A is a front view of the card connector viewed from the side of its inserting opening;

FIG. 3B is a bottom plan view of the card connector shown in FIG. 3A;

FIG. 4A is a perspective view of the card connector with a card inserted in its upper portion; and

FIG. 4B is a perspective view similar to FIG. 4A with a card inserted in the lower portion.

### DESCRIPTION OF THE PREFERRED EMBODIMENTS

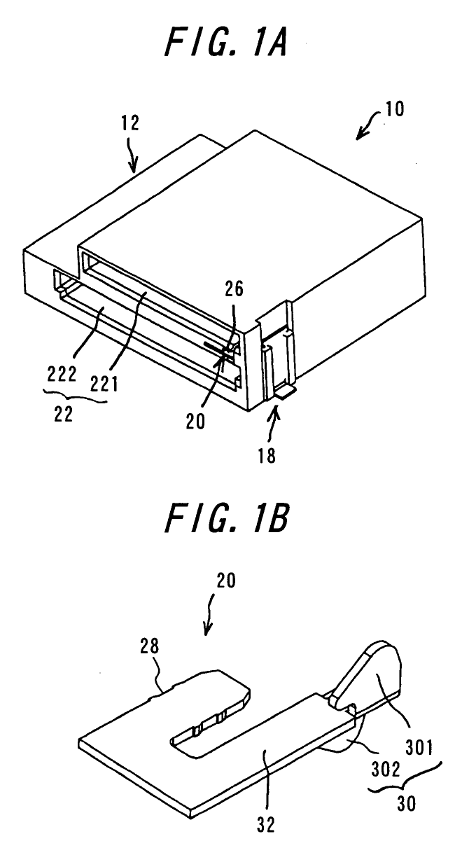

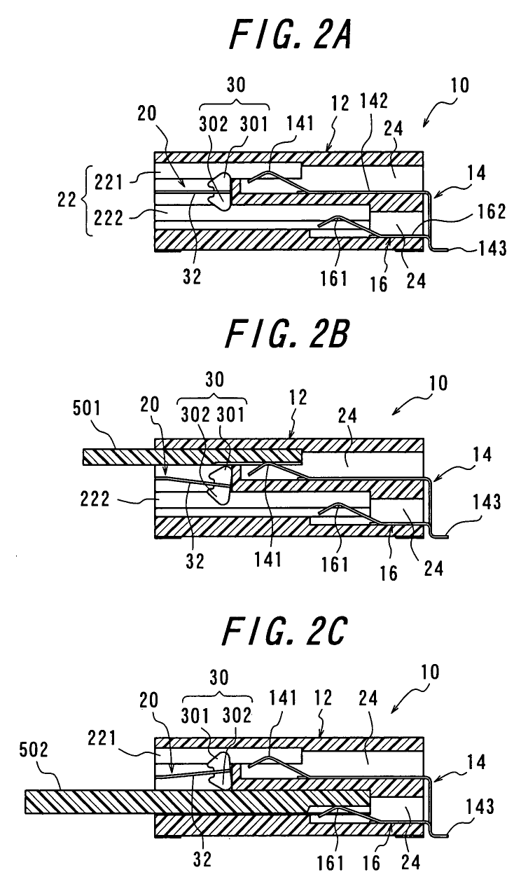

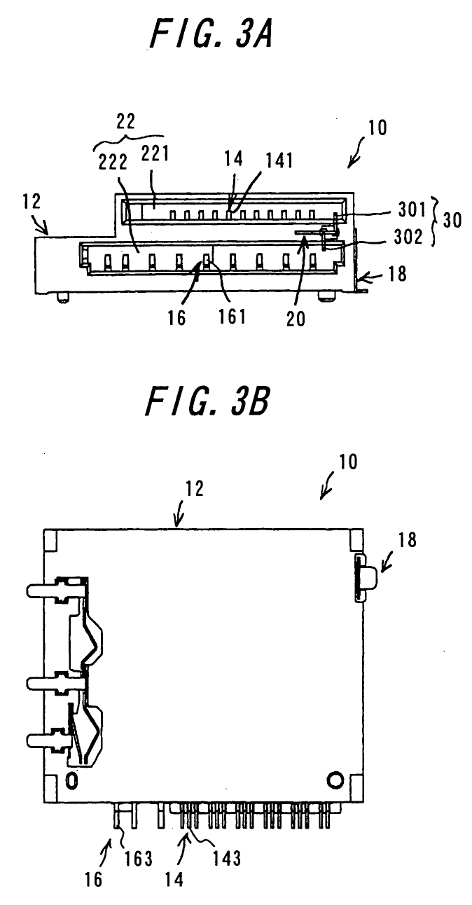

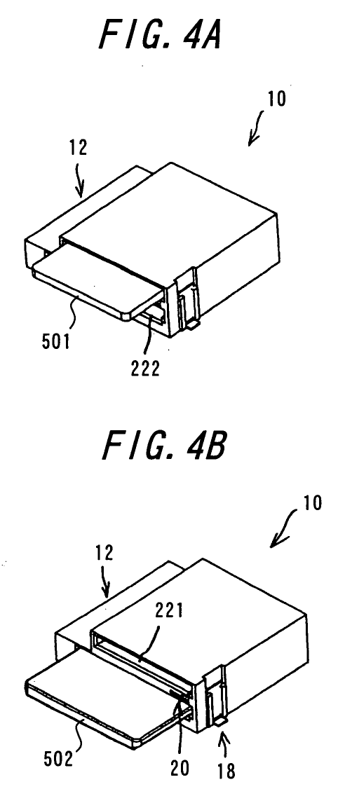

One embodiment of the card connector according to the invention will be explained with reference to FIGS. 1A to 4B. FIG. 1A is a perspective view of a card connector according to the invention and FIG. 1B is a perspective view of an insertion-preventing member. FIG. 2A is a cross-sectional view of the connector taken along the insertion-preventing member, while FIG. 2B is a cross-sectional view similar to FIG. 2A with a card inserted in the upper portion of the connector and FIG. 2C is also a cross-sectional view similar to FIG. 2A with a card inserted in the lower portion of the connector. FIG. 3A is a front view of the card connector viewed from the side of its inserting opening, while FIG. 3B is a bottom plan view of the card connector shown in FIG. 3A. FIG. 4A is a perspective view of the card connector with a card inserted in its upper portion, while FIG. 4B is a perspective view similar to FIG. 4A with a card inserted in the lower portion.

The card connector according to one embodiment of the invention mainly comprises a housing 12, two kinds of contacts 14 and 16, a fixture 18, and an insertion-preventing member 20.

Before explaining the components of the card connector, the cards 50 will be explained. The cards 50 are used for printers, card readers and the like. The cards 50 each mainly comprise contact portions adapted to contact the contact portions 141, 161 of the contacts 14 and 16, patterns connecting from the contact portions of the card to circuits, and connection portions adapted to be connected to integrated circuits and central processing units mounted on the patterns. Cards 50 to be used for the card connector 10 according to the invention include Multimedia card®, SD card (Secure Digital memory card)®, Mini-SD card (Mini Secure Digital memory card)®, Memory Stick card®, SmartMedia card®, CompactFlash card®, xD card®, RS-MMC card (Reduce Size MMC card)®, Transflash card®, S card®, Memory-stick Duo card® and the like, these being IC cards having built-in CPU or IC for memory.

The card connector 10 according to the present embodiment is constructed to have an upper portion into which a Mini-SD card (Mini Secure Digital memory card)® 501 can be inserted, and a lower portion into which an SD card (Secure Digital memory card)® 502 can be inserted.

First, the insertion-preventing member 20 will be explained, which is one important aspect of the invention. The insertion-preventing member 20 in the embodiment is made of a metal and formed by means of the press-working of the known technique. Preferred metals from which to form said insertion-preventing member 20 include brass, beryllium copper, phosphor bronze and the like which comply with the requirements as to dimensional stability, workability, springiness, and the like. An electrically insulating plastic material may be used for the insertion-preventing member 20 insofar as it fulfills functions described below. In this case, the plastic materials suitable for the housing 12 described later may be used for the insertion-preventing member 20.

Said insertion-preventing member 20 fulfils its imposed function as follows. When one memory card 50 is inserted into one inserting opening 22, one of projections 30, that is, an upper projection 301 or a lower projection 302 is pushed by the memory card 50 downwardly or upwardly so that an elastic portion 32 of the member 20 is displaced or deformed downwardly or upwardly, with the result that one of the projection, that is, the projection 302 or 301 is extended into the other inserting opening 22. In this way, a further memory card cannot be inserted and hence only one memory card 50 is permitted to be inserted. The insertion-preventing member 20 comprises at least a holding portion 28 for holding the member 20 in said housing 12, the elastic portion 32 having an elasticity provided contiguously to the holding portion 28, and the upper projection 301 and a lower projection 302 located at a tip of the elastic portion 32.

Said holding portion 28 and elastic portion 32 are plate-shaped and they are connected to each other to form an L-shape. Said elastic portion 32 is provided at the tip with the projections 30 extending upwardly and downwardly by bending substantially perpendicularly so as to extend into inserting openings 22 of said housing 12, respectively. Shapes and sizes of the upper projection 301 and the lower projection 302 provided one above the other may be suitably designed in consideration of the function of said insertion-preventing member 20, the extending of the projections 301 and 302 into the inserting openings 22 of the housing 12, the risk of damage of the memory card 50, and the strength and workability of the member 20. In the illustrated embodiment, tips of the projections are rounded in the form of R-shape.

Said elastic portion 32 only needs to be displaced or deformed by the movement of either of the projections 30 pushed by either of the memory cards 50 inserted. For example, when the memory card 501 is inserted into the upper inserting opening 221 of said housing 12, the upper projection 301 is pushed by said memory card 501 to be displaced downwardly so that the lower projection 302 extends into the lower inserting opening 222. The shape and size of said elastic portion may be suitably designed in consideration of such functions, its springiness and amount of displacement, the strength of said housing and the like.

The shape and size of said holding portion 28 may be any ones so long as the insertion-preventing member 20 can be held in the housing 12 to enable the functions described above to be fulfilled.

The housing 12 will be explained. The housing 12 is formed from an electrically insulating plastic material by means of the injection molding of the known technique. The materials for the housing 12 may be suitably selected in consideration of dimensional stability, workability, manufacturing cost, and the like and in general include polybutylene terephthalate (PBT), polyamide (66PA or 46PA), liquid crystal polymer (LCP), polycarbonate (PC) and the like and combination thereof.

Said housing 12 is provided with the two inserting openings 221 and 222 for inserting two kinds of the memory cards 501 and 502. The card connector in the illustrated embodiment is so constructed that two kinds of memory cards 501 and 502 can be inserted into the housing 12. The shapes and sizes of said inserting openings 221 and 222 are made to be comparable to the memory cards 501 and 502, respectively. Said upper and lower inserting openings 221 and 222 are arranged one above the other substantially in a parallel relationship. A Mini-SD card® 501 is inserted into the upper inserting opening 221 and an SD card® 502 is inserted into the lower inserting opening 222.

Moreover, said housing 12 is formed with inserting holes 24 in which two kinds of contacts 14 and 16 are installed corresponding to the two cards 501 and 502 to be inserted into said housing 12. The contacts 14 and 16 are fixed to the housing by means of press-fitting, hooking (lancing), welding and the like.

Said housing 12 is formed with an inserting groove 26 on the side of said inserting openings 22, into which said insertion-preventing member 20 is inserted. Said inserting groove 26 is located between said upper and lower inserting openings 221 and 222 arranged one above the other such that the insertion-preventing member inserted in the groove 26 does not contact said two kinds of the contacts 14 and 16 in order to prevent contact portions of said memory cards 50 from being scratched.

Said inserting groove 26 mainly consists of a part for receiving the holding portion 28 of the insertion-preventing member 20, and a part for accommodating said elastic portion 32 in a displaceable manner. The part for receiving the holding portion 28 only needs to be able to receive the holding portion 28 and to hold the insertion-preventing member 20. The part for accommodating said elastic portion 32 only needs to permit the elastic portion 32 to be displaced when either of the projections 30 is pushed by either of the memory cards 50 which is inserted. In other words, when one of the projections 30 is pushed by the card, the other projection 30 only need to extend into the inserting opening into which a card has not been inserted yet, with the aid of the displacement or deformation of the elastic portion 32. Said inserting groove 26 may be suitably designed in consideration of such functions, the strength of said housing 12 and the like.

The two kinds of the contacts 14 and 16 will then be explained. The two kinds of the contacts 14 and 16 are made of a metal and formed by means of the press-working of the known technique. Preferred metals from which to form said contacts 14 and 16 include brass, beryllium copper, phosphor bronze and the like which comply with the requirements as to springiness, electric conductivity, and the like.

The contacts 14 and 16 of the two kinds each mainly comprise a contact portion 141, 161 adapted to contact a connection portion of the memory card 50, a fixed portion 142, 162 to be fixed to said housing 12, and a connection portion 143, 163 to be connected to a substrate. In other words, among the contacts of the two kinds, the contacts having the contact portion 141 extending into the upper inserting opening 221 are the contacts 14 for the Mini-SD card, while the contacts having the contact portion 161 extending into the lower inserting opening 222 are the contacts 16 for the SD card. The connection portions 143 and 163 of the contacts 14 and 16 of the two kinds may be suitably designed in consideration of circuit design and occupied area of the substrate, and a size and design of the connector. In the illustrated embodiment, the connection portions 143 and 163 of the contacts 14 and 16 of the two kinds extend onto the side of the housing 12 opposite from the inserting openings 22 and are of a surface mounting type (SMT) as shown in FIGS. 2A to 2C.

Moreover, the contact portions 141 and 161 of the contacts 14 and 16 of the two kinds extend into the inserting openings 221 and 222, respectively, so as to be able to contact the inserted memory cards 50. The positions of said contact portions may be suitably designed in consideration of the positions of the connection portions of the memory cards 50. The extending amounts of the contact portions of the contacts may be suitably designed in consideration of contact pressure acting on the memory cards 50.

Said fixture 18 will then be explained. The fixture 18 is made of a metal and formed by means of the press-working of the known technique. Preferred metals from which to form said fixture 18 include brass, beryllium copper, phosphor bronze and the like which comply with the requirements as to workability, soldability, and the like.

The fixture 18 has a substantially L-shaped cross-section and serves to fix the card connector 10 to the substrate securely.

Finally, the operation of the insertion-preventing member 20 will be explained. The case that the card 501 is inserted into the upper inserting opening 221 will be explained by way of example.

First, when the memory card 501 is inserted into the upper inserting opening 221 of said housing 12, the memory card 501 comes into contact with the upper projection 301 of said insertion-preventing member 20.

Said memory card 501 is further inserted into the upper inserting opening 221 so that the upper projection 301 is pushed to cause said elastic portion 32 to be displaced or deformed downwardly.

Upon downward displacement of the elastic portion 32, the lower projection 302 of said insertion-preventing member 20 extends into the lower inserting opening 222, that is, into the space in which the card 501 is not inserted.

Under such a condition that said lower projection 302 has extended into said lower inserting opening 222, even if a memory card 502 corresponding to the lower inserting opening 222 is inserted into the lower inserting opening 222, said memory card 502 will abut against said lower projection 302 so that the memory card 502 could not be further inserted into the lower inserting opening 222.

If required, further, switch structures may be provided for confirming insertion and removal of the cards 50 as shown in FIG. 3B. In other words, a plurality of terminals are provided to enable the insertion and removal of the cards to be recognized by ON and OFF of the terminals.

While the card connector 10 is shown and explained, which has the structure of the upper inserting opening into which the Mini-SD card (Mini Secure Digital memory card)® is inserted and the lower inserting opening into which the SD card (Secure Digital memory card)® is inserted, it will be apparent that the invention may employ other structures enabling other cards to be used.

Examples of applications of the present invention include card connectors for use in various electric and electronic appliances such as printers, card readers and the like and particularly card connectors with a structure permitting only one memory card to be inserted into the card connector at a time.

While the invention has been particularly shown and described with reference to the preferred embodiments thereof, it will be understood by those skilled in the art that the foregoing and other changes in form and details can be made therein without departing from the spirit and scope of the invention.

1. A card connector into and from which two memory cards are detachably inserted and removed, including contacts of two kinds for said two memory cards, respectively, each adapted to contact a connection portion of the memory card, and a housing having two inserting openings each into which the respective memory card is inserted and arranging and holding said contacts,
wherein said two inserting openings provided in said housing are arranged one above the other substantially in parallel relationship, and an insertion-preventing member is arranged in a position between said inserting openings so as not to contact said contacts of two kinds so that once either of the memory cards has been inserted, the other memory card is prevented from being inserted by means of said insertion-preventing member.

2. The card connector as set forth in claim 1, wherein said insertion-preventing member at least comprises a holding portion for holding the insertion-preventing member in said housing, an elastic portion having an elasticity and being contiguous to said holding portion, and two projections consisting of an upper projection and a lower projection located at a tip of said elastic portion, and said housing is formed with an inserting groove for receiving said insertion-preventing member therein so as to permit the elastic portion of said insertion-preventing member to be displaceable.

3. The card connector as set forth in claim 1, wherein when either of said two memory cards has been inserted into one of the inserting openings, one of said two projections is pushed by said memory card so that said elastic portion is displaced to cause the other projection to extend into the other inserting opening, thereby permitting only one memory card to be inserted at a time.

4. The card connector as set forth in claim 2, wherein when either of said two memory cards has been inserted into one of the inserting openings, one of said two projections is pushed by said memory card so that said elastic portion is displaced to cause the other projection to extend into the other inserting opening, thereby permitting only one memory card to be inserted at a time.
